(19) United States
(12) Patent Application Publication
(10) Pub. No.: US 2004/0130496 A1
(43) Pub. Date: Jul. 8, 2004

(54) Diversity antenna and method for controlling the same

(76) Inventors: Hiroshi Iijima, Osaka-shi (JP); Hidetoshi Oka, Osaka-shi (JP); Hideaki Oshima, Osaka-shi (JP)

Correspondence Address: MERCHANT & GOULD PC, P.O. BOX 2903, MINNEAPOLIS, MN, 55402-0903, US

(21) Appl. No.: 10/479,941

(22) PCT Filed: Jun. 4, 2002
(86) PCT No.: PCT/JP02/05495

(30) Foreign Application Priority Data
Jun. 4, 2001 (JP) 2001-167779

(51) Int. Cl. H01Q 1/32

(52) U.S. Cl. 343/713; 343/876

(57) ABSTRACT

A diversity antenna system of the present invention includes: two antennas of different directionality, the two antennas generating two signals; a synthesizing means for generating a synthesized signal by synthesizing the two signals; a selection means for selecting either one selected from the group consisting of the two signals and the synthesized signal; and a selection controlling means for controlling the selection means. When the intensities of the two signals are not higher than a predetermined value, the selection controlling means controls the selection means such that the selection means fixedly selects the synthesized signal. According to the diversity antenna, excellent receptive conditions can be obtained even in weak electric fields.

### FIELD OF THE INVENTION

The present invention relates to an antenna system capable of diversity reception and a method for controlling the same, and in particular to a diversity antenna system that is applicable for a vehicle and suitable for FM broadcast reception, and a method for controlling the same.

### BACKGROUND OF THE INVENTION

For glass antenna devices formed on a window glass of a vehicle, the present applicant has proposed the following as glass antenna devices that are capable of diversity reception wherein a signal from a plurality of antennas is synthesized. These are JP 2000-252895 A and JP 2000-269870 A. Additionally, JP H10 (1998)-75202 A proposes electrically processing a received signal to obtain omnidirectionality.

JP 2000-252895 A relates to “a TV diversity system to be installed in vehicles, including a plurality of TV antennas provided on a vehicle with an interval between one another; a plurality of phase-shifters for shifting the phase of a signal received from at least one TV antenna by a shift amount that differs among the phase-shifters; a plurality of synthesizing means for synthesizing the output signals of the plurality of phase-shifters and the output signal of the other TV antennas; and a received signal switching means for comparing the plurality of synthesized received signals, which are synthesized by the synthesizing means, and the received signal output from the TV antennas, or for comparing the plurality of synthesized received signals synthesized by the synthesizing means, wherein the received signal switching means selects the received signal of the highest level and sends it to a television.”

JP 2000-269870 A relates to “a TV diversity system to be installed in vehicles, including two TV antennas; two amplification means for performing impedance matching and amplification of the signals received by the two TV antennas; a phase-synthesizing means for synthesizing the received signals supplied by the two amplification means with a fixed phase; a selecting means for selecting one received signal from among a phase-synthesized signal supplied by the phase-synthesizing means and the signals supplied by the two amplification means; and a selection controlling means for controlling the selecting means such that it selects the received signal of the greatest level.”JP H10 (1998)-75202 A relates to “a glass antenna device for a vehicle, wherein a first antenna is provided on a window glass sheet of a vehicle, a second antenna is provided on a window glass sheet of the vehicle or on a portion of the vehicle other than its window glass sheets, and wherein the phase difference between the signal received by the first antenna and the signal received by the second antenna is detected, the phase of the signal received by either the first antenna or the second antenna is changed by a variable phase shifter according to that phase difference, and the received signal of the first antenna and the received signal of the second antenna are synthesized by a synthesizing circuit and delivered to a receiver.”

In JP 2000-252895 A and JP 2000-269870 A, the diversity systems are configured using the signals from two antennas and a signal synthesized from the signals from those antennas.

In JP H10 (1998)75202 A, there is an improvement in the reception sensitivity of “the antenna for FM broadcasts, wherein the phase difference is changed significantly in accordance with the incoming direction of the electromagnetic wave” due to the short wavelengths,

Diversity antenna systems carry out reception while selecting an antenna with excellent reception sensitivity in an intense electric field, and thus can obtain excellent sensitivity. On the other hand, in a weak electric field, the reception sensitivity is not improved even if the antenna is switched, and carrying out diversity reception on the contrary leads to switching noise that can be heard. Thus, antennas are fixed and reception is performed. Consequently, for antennas used in a weak electric field, omnidirectionality is desirable.

However, it is generally preferable that the antennas that are part of a diversity antenna system have a directionality that is complementary to one another. For that reason, antennas that are always used in weak electrical fields have a particular directionality. Such antennas are not omnidirectional. Consequently, in weak electric fields, reception had to be carried out by an antenna with poor reception sensitivity in at least one particular direction, and it was difficult to obtain excellent reception conditions.

### DISCLOSURE OF THE INVENTION

A diversity antenna system of the present invention includes: two antennas of different directionality, the two antennas generating two signals; a synthesizing means for generating a synthesized signal by synthesizing the two signals; a selection means for selecting either one selected from the group consisting of the two signals and the synthesized signal; and a selection controlling means for controlling the selection means. When the intensities of the two signals are not higher than a predetermined value, the selection controlling means controls the selection means such that the selection means fixedly selects the synthesized signal. The predetermined value depends on the design and property of the antenna system and generally is the lowest signal intensity that ensures a practical receiving.

In the diversity antenna system, the synthesizing means may synthesize the two signals in phase.

### BRIEF DESCRIPTION OF THE DRAWINGS

FIG. 1 is a block diagram of a first embodiment of a diversity antenna system in accordance with the present invention.

FIG. 2 illustrates the antenna pattern used for measuring a directional pattern for vertically polarized waves.

FIGS. 3A to 3C illustrate a directional pattern during reception of vertically polarized waves. FIG. 3A illustrates a directional pattern of a right side glass antenna; FIG. 3B illustrates a directional pattern of a left side glass antenna; and FIG. 3C illustrates a directional pattern of a synthesized signal from the right and left antennas.

FIG. 4 is a block diagram of a second embodiment of a diversity antenna system in accordance with the present invention.

FIG. 5 illustrates the antenna pattern used for measuring a directional pattern for horizontally polarized waves.

FIGS. 6A to 6C illustrate a directional pattern during reception of horizontally polarized waves. FIG. 6A illustrates a directional pattern of a right side glass antenna; FIG. 6B illustrates a directional pattern of a left side glass antenna; and FIG. 6C illustrates a directional pattern of a synthesized signal from the right and left antennas.

FIG. 7 is a circuit diagram illustrating an example of the configuration of a phase-shifter.

FIG. 8 is a block diagram of a third embodiment of a diversity antenna system in accordance with the present invention.

FIG. 9 is a block diagram of a fourth embodiment of a diversity antenna system in accordance with the present invention.

### DETAILED DESCRIPTION OF THE INVENTION

The diversity antenna system of the present invention further may include a phase-shifting means for shifting the phase of one signal selected from the two signals. The one signal is supplied from the phase-shifting means to the synthesizing means. The phase-shifting means preferably includes a reverse coupling transformer for 180° phase-shifting.

The diversity antenna system further may include an amplifying circuit for amplifying at least one of the two signals. The diversity antenna system preferably includes two amplifying circuit for amplifying the two signals, respectively.

In the diversity antenna system, the two antennas are glass antennas formed on a glass sheet.

The present invention further provides a method for controlling a diversity antenna system including two antennas of different directionality. This method includes: generating a synthesized signal from the two signals that are generated by the two antennas; and selecting either one selected from the group consisting of the two signals and the synthesized signal, wherein when the intensities of the two signals are not higher than a predetermined value, the synthesized signal is always selected.

In this method, the two signals may be synthesized in phase or at anti-phase.

One aspect of the diversity antenna system of the present invention is that in weak electric fields, the signals from the two antennas, which are of a different directionality, are synthesized for obtaining a virtual less-directional antenna signal, and in fixedly selecting and receiving that synthesized signal.

Another aspect is that, in a weak electric field, the synthesized signal is always received without performing diversity reception controls according to the signal received from the two antennas with different directionality.

A preferable embodiment of the present invention provides an antenna system in a diversity antenna system that permits diversity reception with directionality during reception in intense electric fields, and that can obtain a received signal with less-directionality, preferably omnidirectionality, during reception in weak electric fields.

The diversity antenna system of the present invention may be designed such that FM broadcasts are received. The frequency band of FM broadcasts has a range of 76 to 108 MHz, and FM frequency bands differ from area to area.

Moreover, the polarized wave arrangement in FM broadcasts differs according to the area, with arrangements including horizontally polarized waves, vertically polarized waves, and a mixture of horizontally and vertically polarized waves.

An embodiment of the present invention is described below based on the accompanying drawings.

### FIRST EMBODIMENT

In this embodiment, a phase-shifter is not used, and in-phase synthesis is performed.

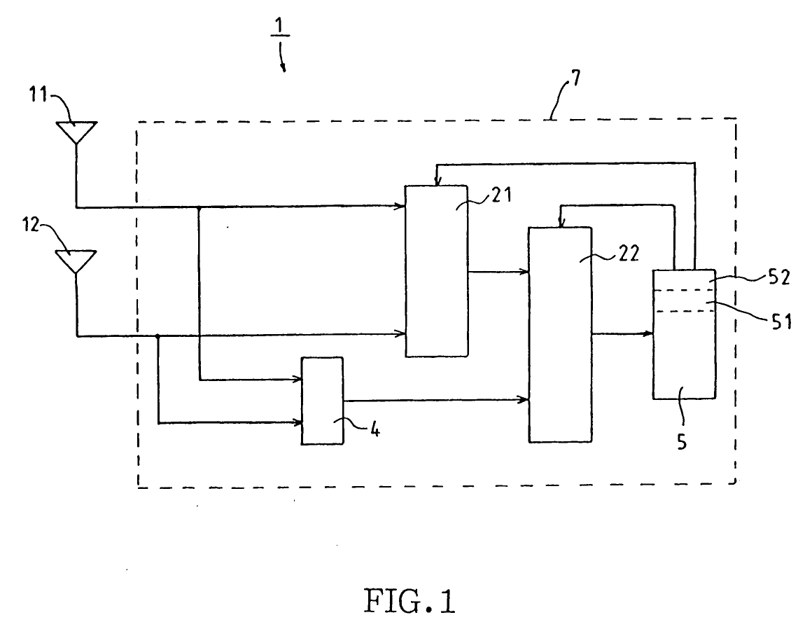

In FIG. 1, a diversity antenna system 1 includes a first antenna 11 and a second antenna 12. The antennas 11 and 12 can be provided on the left and right side-windows of a car, for example.

The signal received with the first antenna 11 is inputted into a first switch 21, and also is inputted to a synthesizer 4. Similarly, the signal received with the second antenna 12 is inputted to the first switch 21 and also is inputted to the synthesizer 4.

With a control signal from a tuner 5, the first switch 21 switches between the signal from the first antenna 11 and the signal from the second antenna 12.

The synthesizer 4 produces the signals from the first antenna 11 and the second antenna 12, and sends this synthesized signal to a second switch 22. With a control signal from the tuner 5, the second switch 22 selects a signal from among the first switch 21 and the synthesizer 4. Then, the selected signal is sent to the tuner 5.

The tuner 5 is provided with a signal level comparison circuit 51 for determining the intensity level of a received signal. The signal level comparison circuit 51 monitors the intensity of the signals from the first antenna 11 and the second antenna 12. When those results show that the signal intensity of the first antenna 11 and the second antenna 12 are both of a predetermined value indicating a weak electric field, the signal that is supplied by the synthesizing means always should be selected. The tuner 5 is provided with a selection controlling portion 52, which acts a selection controlling means that includes such a function.

On the other hand, the selection controlling portion 52 also includes the function of sending a control signal to the second switch 22 such that when the signal intensity from the first antenna 11 and the second antenna 12 both indicate an intense electric field, the second switch 22 selects the signal from the first switch 21. Further, the selection controlling portion 52 sends a control signal to the first switch 21 to carry out diversity reception using the first antenna 11 and the second antenna 12. The first and second antennas are formed such that their directional characteristics are different. Specifically, if there is a significant difference in their attaching positions on a vehicle, the influence of metallic portions of the vehicle body causes the directionalities of the antennas to differ from one another. The attaching position for the two antennas is not limited to the left and right side windows. The antennas can be provided on the left and right areas of the rear glass, or on the windshield and rear glass.

The patterns of the first and second antennas can be different, they can be of a similar pattern shape, or they can be a mirror image of one another. Preferably the antennas are of a so-called glass antenna type that is made of a printed film or a thin wire on a glass sheet.

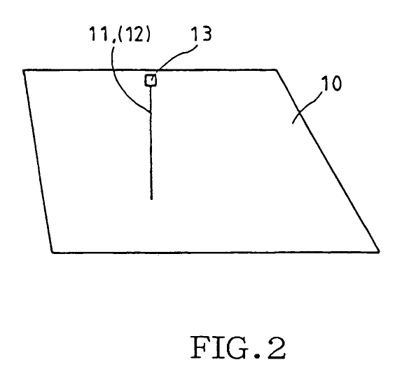

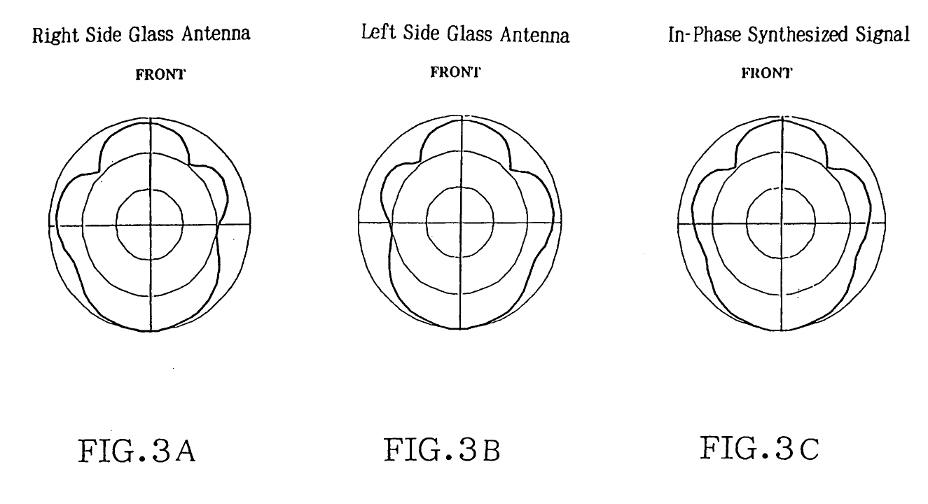

FIG. 2 shows an example of the first and second antennas, which are, for example, made of substantially vertical antenna elements. In this example, the first antenna and second antenna are provided on the side windows 10. FIGS. 3A to 3B show an example of the directional patterns of these two antennas when they receive vertically polarized waves. It should be noted that here the first and second antennas mirror one another on the left and right side windows.

A frequency of 100 MHz was used from the FM broadcast band of 76 to 108 MHz, and was measured in a radio-wave anechoic chamber.

FIGS. 3A to 3C show the directional pattern when receiving vertically polarized waves of 100 MHz. FIG. 3A is the directional pattern of the first antenna, which is provided on the right side glass, and FIG. 3B is the directional pattern of the second antenna, which is provided on the left side glass. Furthermore, FIG. 3C is the directional pattern of a signal wherein the signals from these two antennas have been synthesized in-phase.

Here, when the flatness of the directional pattern at (average reception sensitivity-minimum reception sensitivity) was assessed, the first and second antennas were 14.1 dB, and the in-phase synthesized signal was 13.6 dB. It is clear from these results that synthesizing in-phase improves the flatness of the directional pattern by 0.5 dB.

Comparing the average values of their reception sensitivities, the reception sensitivity of the first and second antennas was −5.4 dB, while the reception sensitivity of the signal of those two received signals synthesized at anti-phase was −5.2 dB. These results demonstrate that the reception sensitivity improved by 0.2 dB.

In the diversity antenna system, with regard to diversity reception in intense electric fields, controls that are carried out in regular diversity reception should be carried out. For example, first the first antenna is selected and the reception level thereof is monitored, and if it is at or below a predetermined value, the second antenna is selected. And if the reception level of the second antenna is at or below a predetermined value, the first antenna should be selected.

Should the signal intensity of the signal received by the first and second antennas both be at or below a predetermined value, the following controls are performed. During reception in a weak electric field, the system is controlled so as to always select the signal synthesized by the synthesizing means from the received signals of the first and second antennas.

In this way, the synthesized signal is always selected, and switching control according to diversity reception is not carried out during reception in weak electric fields. Thus, switching noise at the time of switching is not generated, and therefore preferable reception can be carried out.

If the reception level recovers to the predetermined value, diversity reception as explained above should be carried out.

For diversity reception in intense electric fields, the diversity antenna system of the present invention may have the characteristic of using the signals from the first and second antennas, which have directionality, and not using the synthesized signal of the signals. When the intensities of the two signals received by the first and second antennas are higher than the predetermined value, the selection controlling means preferably controls the selection means such that the selection means selects either one of the two signals. When the intensity of either one selected from the two signals is higher than the predetermined value and that of the other is lower than the predetermined value, the selection controlling means preferably controls the selection means such that the selection means selects the signal of higher intensity. These are because in an intense electric field, antennas with omnidirectionality receive a plurality of reflected waves, and thus on the contrary are subject to multipath interference.

In contrast to this, the above-mentioned JP 2000-252895A and JP 2000-269870A both provide a diversity system for TV reception, and carry out diversity reception using the synthesized signal as well.

### SECOND EMBODIMENT

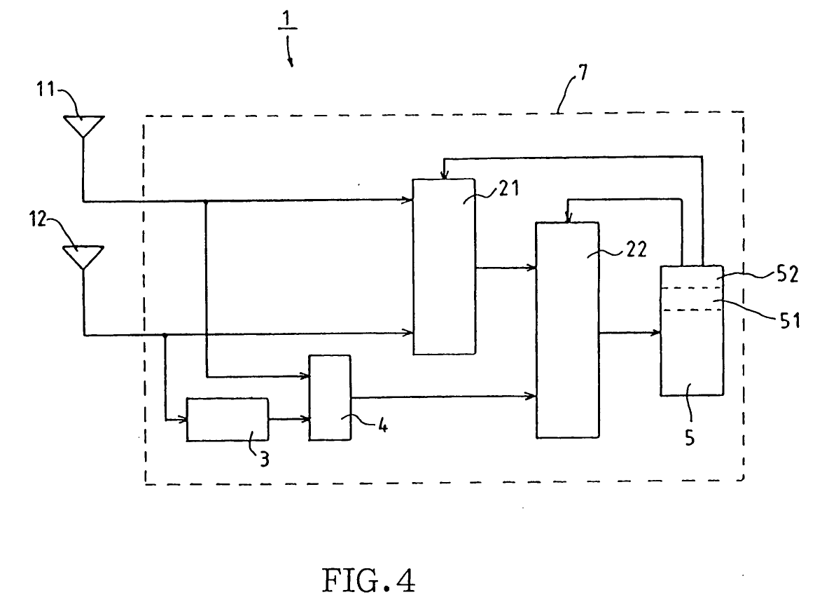

FIG. 4 is a block diagram of a second embodiment of the diversity antenna system according to the present invention. This second embodiment of the present invention adds a phase-shifter to the first embodiment described above.

In FIG. 4, the signal received with a first antenna 11 is input to a first switch 21 and a synthesizer 4. The signal received with a second antenna 12 is input to the first switch 21 and a phase-shifter 3.

The first switch 21 switches between the signals from the first antenna 11 and the second antenna 12 according to a control signal from a tuner 5.

The synthesizer 4 synthesizes the signal directly inputted from the first antenna 11 and the input from the phase-shifter 3, and sends the synthesized signal to a second switch 22. The second switch 22 switches between the signal from the first switch 21 and the signal from the synthesizer 4 according to a control signal from the tuner 5. Then the signal selected by the second switch 22 is sent to the tuner 5.

In this second embodiment, like in the first embodiment described above, regular diversity reception control should be carried out in intense electric fields, and selection control for always selecting the synthesized signal should be carried out in weak electric fields.

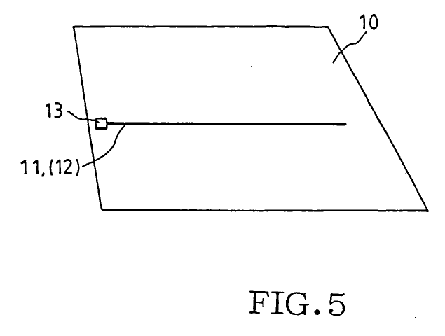

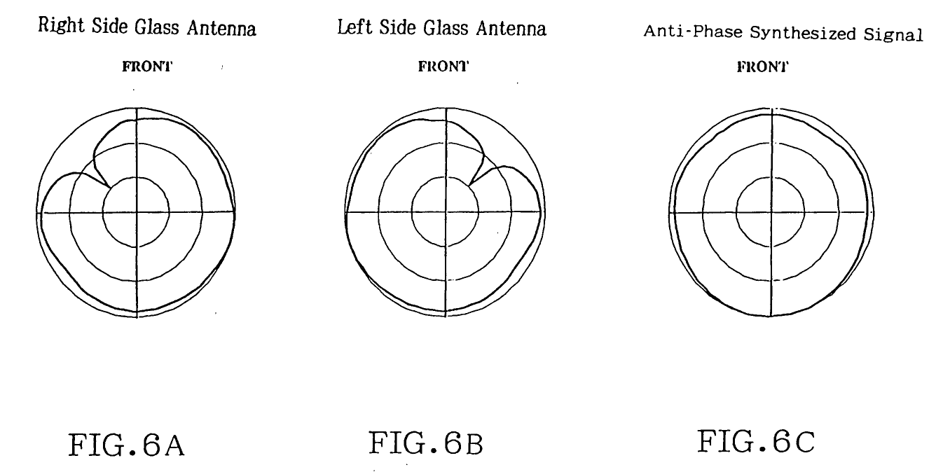

For example, FIG. 5 shows an example of the first and second antennas made of a substantially horizontal antenna element. In this example, the first antenna and the second antenna are provided on the side windows. FIG. 6 shows an example of the directionality of these two antennas when a horizontally polarized wave is received. The first and second antennas are provided on the left and right side windows in a mirror image to one another.

A frequency of 80 MHz was used from the FM broadcast band of 76 to 108 MHz, and was measured in an anechoic chamber.

FIGS. 6A to 6C show the directional pattern of reception of horizontally polarized waves of 80 MHz. FIG. 6A is the directional pattern of the first antenna, which is provided on the right side glass, and FIG. 6B is the directional pattern of the second antenna, which is provided on the left side glass. It can be seen that a dip exists in the directional pattern of both the first antenna 11 and the second antenna 12, the cause of which seems to be the attaching position of the antennas. FIG. 6C is the directional pattern of a signal wherein the signals from the first and second antennas have been synthesized at anti-phase.

This diagram demonstrates that the synthesized signal attains omnidirectionality of a substantially circular shape. Furthermore, when the flatness of their directional patterns was assessed, the first antenna and second antenna were at 35.1 dB, and the anti-phase synthesized signal was at 2.6 dB. These results show that by synthesizing at anti-phase, a virtual antenna can be obtained that is substantially omnidirectional.

Comparing the average values of their reception sensitivity, the reception sensitivity of the first and second antennas was −3.7 dB, while the reception sensitivity of the signal of those two received signals synthesized at an anti-phase was −2.5 dB. These results confirm a 1.2 dB improvement in reception sensitivity.

As shown in the second embodiment, in the diversity antenna system of the present invention, a phase-shifter is provided that can output a signal of anti-phase with respect to the reception of horizontally polarized waves. In the first embodiment, it was sufficient to synthesize a signal in phase with the reception of vertically polarized waves, and it was unnecessary to provide a phase-shifter.

Depending on the reception area of the antenna system, it should be decided whether to conduct in-phase synthesis or anti-phase synthesis. In a system in which horizontally polarized waves and vertically polarized waves are mixed together, the reception of vertically polarized waves should be given primary consideration, although it depends also on other conditions.

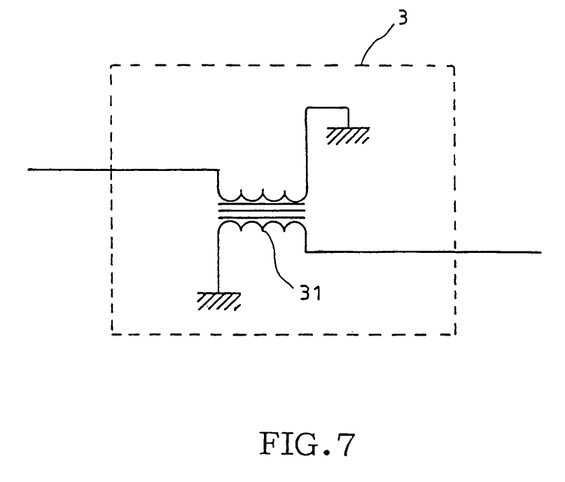

Here, “anti-phase” means a phase shifted 180°, and for this a reverse coupling transformer can be used (see FIG. 7). A phase-shifter of a configuration such as this has the characteristic of a stable phase-shift with respect to frequency changes. Thus, the phase-shifter used in the present invention can be of a simple configuration and inexpensive.

Consequently, in the present invention, when synthesizing the signals received from the first and second antennas, it is unnecessary to carry out a phase comparison with respect to the reception of horizontally or vertically polarized waves, and it suffices when in-phase signals or anti-phase signals can be synthesized. Thus, because it is unnecessary to conduct a phase comparison, synthesis of the signals can be performed regardless of the spacing between the two antennas or the frequency that is received.

### THIRD EMBODIMENT

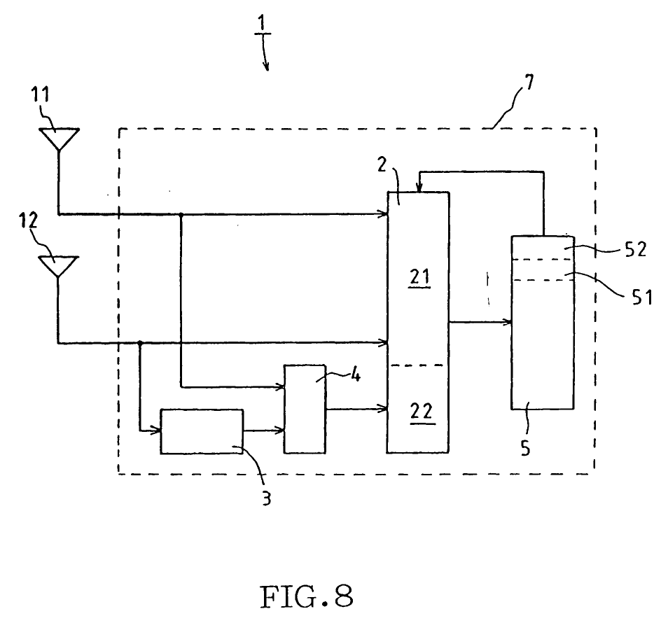

In the above-mentioned first embodiment and second embodiment, a first switch 21 and a second switch 22 were provided. In contrast to this, in this third embodiment the two switches 21 and 22 are combined into a switch 2 (see FIG. 8).

In this third embodiment, as in the other embodiments, in an intense electric field only the signals received by the first antenna and the second antenna serve as the received signal that is supplied for diversity reception, and a synthesized received signal is not used.

In the aforementioned first, second and third embodiments, the reception device 7 included switches (21 and 22, or 2), a phase-shifter 3, a synthesizer 4, and a tuner 5, but the switches, phase-shifter and synthesizer also can be configured as a separate selector portion.

### FOURTH EMBODIMENT

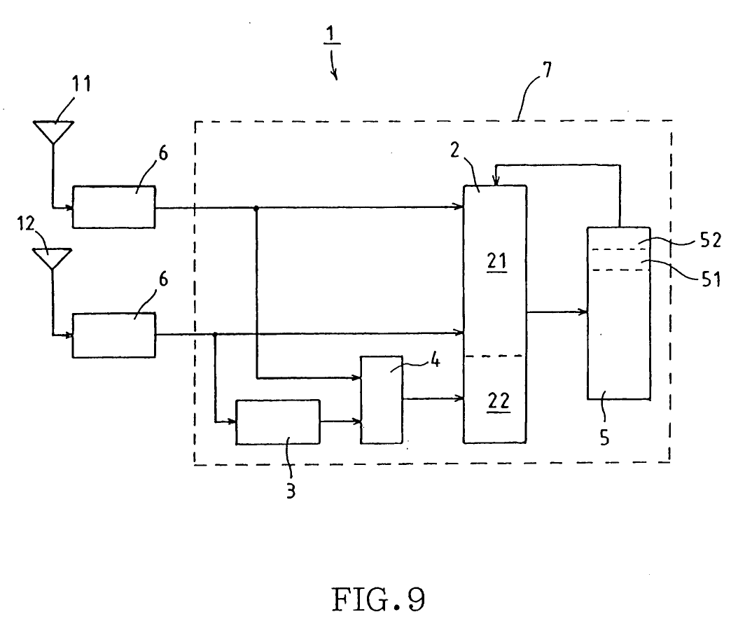

In this fourth embodiment, amplifiers 6 are provided respectively after the first antenna 11 and the second antenna 12 in the third embodiment described above (see FIG. 9). If it appears that reception sensitivity will not be sufficient, amplifiers can be provided, as in this embodiment.

As has been described above, in the diversity antenna system in accordance with at least a preferable embodiment of the present invention, only a received signal with less-directionality that has been synthesized from the signals from the two antennas is used during reception in weak electric fields. For that reason, excellent reception conditions can be maintained even if the vehicle's position relative to the radio mast changes during movement of the vehicle.

Furthermore, the effect that switching noise is not generated during reception in weak electric fields is attained because no switching action of the antenna occurs.

Primarily in reception of intense electric fields, the diversity antenna system of the present invention can perform diversity reception with an antenna that has directionality, and therefore the effects of fading caused by multipath interference can be reduced.

The invention may be embodied in other forms without departing from the spirit or essential characteristics thereof. The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

1. A diversity antenna system comprising:
two antennas of different directionality, the two antennas generating two signals;
a synthesizing means for generating a synthesized signal by synthesizing the two signals;
a selection means for selecting either one selected from the group consisting of the two signals and the synthesized signal; and
a selection controlling means for controlling the selection means,
wherein when the intensities of the two signals are not higher than a predetermined value, the selection controlling means controls the selection means such that the selection means always selects the synthesized signal.

2. The diversity antenna system according to claim 1, wherein the synthesizing means synthesizes the two signals in phase.

3. The diversity antenna system according to claim 1, further comprising a phase-shifting means for shifting the phase of one signal selected from the two signals, wherein the one signal is supplied from the phase-shifting means to the synthesizing means.

4. The diversity antenna system according to claim 3, wherein the phase-shifting means comprises a reverse coupling transformer for 180° phase-shifting.

5. The diversity antenna system according to claim 1, further comprising an amplifying circuit for amplifying at least one of the two signals.

6. The diversity antenna system according to claim 1, wherein the two antennas are glass antennas formed on a glass sheet.

7. A method for controlling a diversity antenna system comprising two antennas of different directionality, the method comprising:
generating a synthesized signal from the two signals that are generated by the two antennas; and
selecting one selected from the group consisting of the two signals and the synthesized signal,
wherein when the intensities of the two signals are not higher than a predetermined value, the synthesized signal is always selected.

8. The method according to claim 7, wherein the two signals are synthesized in phase.

9. The method according to claim 7, wherein the two signals are synthesized at anti-phase.
